(19) United States
(12) Patent Application Publication
(10) Pub. No.: US 2013/0256242 A1
(43) Pub. Date: Oct. 3, 2013

(54) Oil Filter/Cooler

(71) Applicant: Douglas F. Koelfgen, Spearfish, SD (US)

(72) Inventor: Douglas F. Koelfgen, Spearfish, SD (US)

(21) Appl. No.: 13/850,273

(22) Filed: Mar. 25, 2013

Related U.S. Application Data
(60) Provisional application No. 61/619,227, filed on Apr. 2, 2012.

(51) Int. Cl. B01D 27/08

(52) U.S. Cl. CPC B01D 27/08
USPC 210/774; 210/184; 137/338

(57) ABSTRACT

An oil filter/cooler includes a finned metal canister attached to an oil return pipe by a port nut, and houses a replaceable filter cartridge. Oil transport conduits are located on the outside of the fins, transporting oil from the exit port on the motor to the distal end of the oil filter/cooler. The oil is then channeled back toward the oil return pipe, moving radially outward through the replaceable filter cartridge, before traveling again to the center line of the oil filter/cooler and through the port nut and oil return pipe.

### FIELD OF THE INVENTION

The present invention relates to oil filtering, and particularly to filtering of motor oil on a motorcycle or other open engine vehicle wherein it is also desired to cool the motor oil during filtering.

### BACKGROUND OF THE INVENTION

Oil filters for use in filtering motor oil on vehicle engines are well known. In most designs, the oil filter is not an in-line filter (at least not directly in line), but rather filters at a terminal location, with the oil exit port from the engine being directly adjacent the oil return port, i.e., so both ports are on the same, proximal side of the oil filter. In the most common design, using a so-called “spin-on” type oil filter, the oil return port of the engine is a threaded pipe defining a central axis of the oil filter, with the threads being used to hold the oil filter to the engine. A popular size of a spin-on oil return port is a ¾ inch outside diameter pipe with exterior threads (¾-16 UNF class 3 threads). The oil exit port from the engine is next to the oil return pipe, usually fluidly connected to an annular recess encircling the oil return port. After the oil leaves the engine, the oil is filtered through a filter medium, such as radially inward through an accordioned paper filter element. In some arrangements, the oil could alternatively travel in the opposite direction, i.e., entering the filter though the threaded central pipe, moving radially outward through the paper filter element, and exiting the filter adjacent but radially outward from the threaded central pipe.

Some engines perform better if the motor oil is cooled during use. Accordingly, it is known to design an oil filter body with fins to facilitate heat transfer from the filter body. Such a finned filter body can be referred to as a filter/cooler.

The majority of oil filters utilize an outer metal casing, which is part of a disposable filter. However, disposal of the metal casings creates environmental issues. Accordingly, oil filters and filter/coolers are known which have a reusable housing around a disposable filter element. Applicant's U.S. Pat. Nos. 4,401,563 and 5,548,893 show examples of this and are incorporated by reference. Still, improvements can be made to these reusable oil filter/cooler structures.

### BRIEF SUMMARY OF THE INVENTION

The present invention is an oil filter/cooler and a method of filtering and cooling oil. Oil transport conduits are located on the outside of a finned metal housing, transporting oil from the exit port on the motor to the distal end of the oil filter/cooler. The oil is then channeled back toward the oil return port on the engine through the filter element within the finned metal housing. In the preferred embodiment, as the oil moves proximally within the finned metal housing, the oil moves radially outward through the disposable filter element, before traveling again to the center line of the oil filter/cooler and through the return port.

### BRIEF DESCRIPTION OF THE DRAWINGS

FIG. 1 is an exploded perspective view of a preferred embodiment of an oil filter/cooler in accordance with the present invention.

FIG. 2 is a cross-sectional view of the oil filter/cooler of FIG. 1 in use in cooling and filtering oil from an engine, it being noted that which direction is “up” or “down” as depicted depends entirely on the orientation of the oil filter/cooler as determined by the engine.

FIG. 3 is a perspective view of the canister of the oil filter/cooler of FIGS. 1 and 2.

FIG. 4 is a side view (which could be considered a top or plan view if the filter/cooler is oriented on the engine as shown in FIGS. 1 and 2) of the canister of FIGS. 1-3.

FIG. 5 is a proximal end view of the canister of FIGS. 1-4.

FIG. 6 is a distal end view of the canister of FIGS. 1-5.

FIG. 7 is a perspective view of an end cap of the oil filter/cooler of FIGS. 1 and 2.

FIG. 8 is a side view of the end cap of FIGS. 1, 2 and 8.

FIG. 9 is a distal end view of the end cap of FIGS. 1, 2, 8 and 9.

FIG. 10 is a perspective view of a port nut of the oil filter/cooler of FIGS. 1 and 2.

FIG. 11 is a side view of the port nut of FIGS. 1, 2 and 10.

FIG. 12 is a distal end view of the port nut of FIGS. 1, 2, 10 and 11.

FIG. 13 is a perspective view of an alternative port nut for use with the oil filter/cooler of FIGS. 1 and 2.

FIG. 14 is a side view of the port nut of FIG. 13.

FIG. 15 is a distal end view of the port nut of FIGS. 13 and 14.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

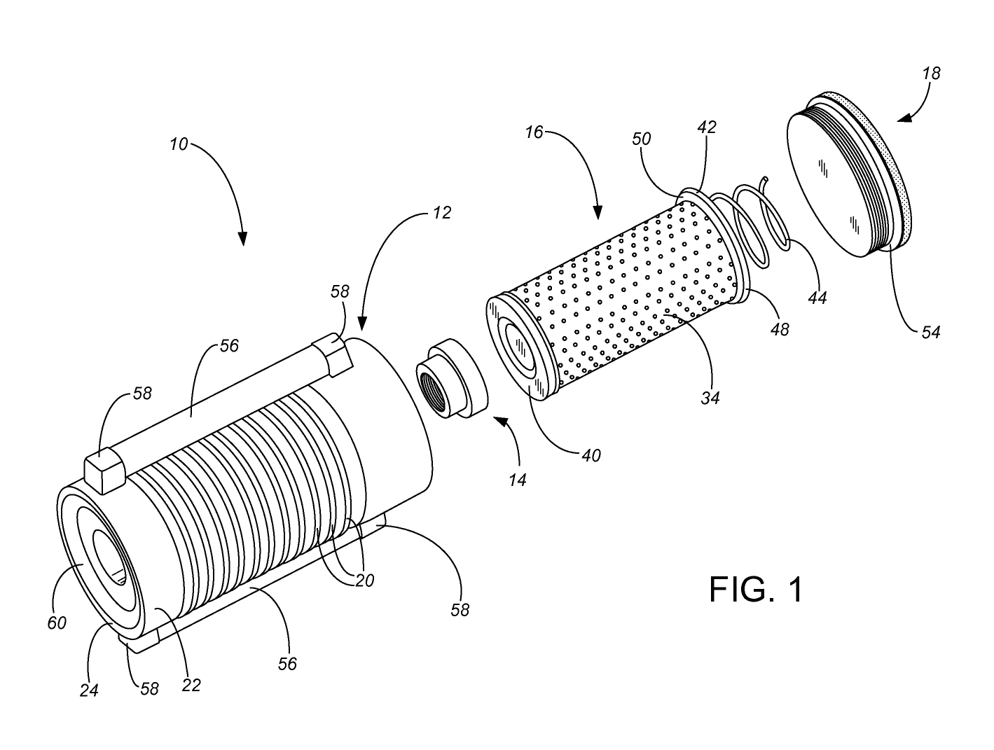

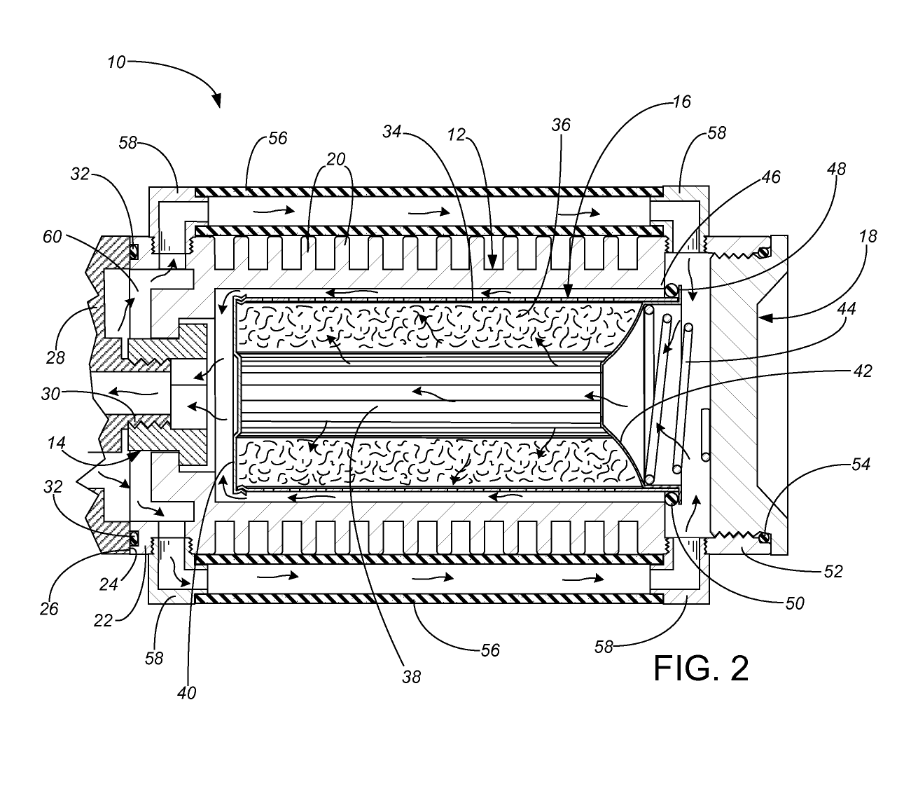

As shown in FIGS. 1 and 2, a preferred embodiment of a filter/cooler 10 of the present invention includes four primary components: a canister 12, a clamp port nut 14, a filter cartridge 16 and an end cap 18. The canister 12 forms the exterior of the filter/cooler 10. The canister 12 is formed from a heat-conducting metal, and includes a number of fins 20 to accelerate heat transfer from the canister 12. In the preferred embodiment, the canister 12 is machined from a solid block of 6061 aluminum to ensure rapid heat transfer through the fins 20 while providing a relatively lightweight but very strong construction. The preferred fins 20 extend circumferentially around the canister 12, which permit air flow in the direction of travel for most motorcycle configurations utilizing the oil filter/cooler 10. The circumferential fins 20 also provide a pleasing ornamental appearance to the filter/cooler 10. Alternatively, the fins could extend longitudinally or at an angle relative to the canister. The canister and its fins could alternatively be formed by bending and shaping sheet metal, which is particularly easy to do if the fins extend longitudinally, and the fins can be formed separately from the canister and then integrally attached to the outside of the canister to facilitate heat transfer from the canister to its fins.

The canister 12 has a proximal end 22 with a circular sealing surface 24 sized to mate with a circular sealing surface 26 on an engine 28 around a threaded oil pipe 30 (shown in FIG. 2). In the preferred embodiment, the canister 12 has an outer diameter of about 3 inches, with the circular sealing surfaces 24, 26 being between about 2.4 and 3 inches in diameter. The clamp port nut 14 includes interior threads sized to mate with exterior threads of the threaded oil pipe 30 of the engine 28 (¾-16 UNF class 3 threads). The clamp port nut 14 can be formed from an appropriate plastic or metal, such as machined from 303 stainless steel. To use the filter/cooler 10, the canister 12 is placed into the proper location on the motor 28, and then the clamp port nut 14 is rotationally advanced on the mating threaded end of the return port pipe 30. The clamp port nut 14 secures the canister 12 relative to the engine 28. To create a seal between the canister 12 and the engine 28, a compressible gasket or o-ring 32 may be housed between the canister 12 and the circular sealing surface 26 of the engine 28. Because it's the clamp port nut 14 and not the canister 12 that mates with the threads on the return port pipe 30, the proximal side 22 of the canister 12 need not include any threads, and the canister 12 does not need to be rotated while attaching it to the engine 28.

The filter cartridge 16 is disposed within the canister 12. For instance, in the preferred embodiment the filter cartridge 16 is a prior art HD-1 filter element, originally described in U.S. Pat. No. 4,401,563 and commercially available from the assignee of the present application. The preferred filter cartridge 16 includes a perforated metallic sheath 34 around a paper filter medium 36 (shown in FIG. 2). The paper filter medium 36 extends in an accordion configuration annularly around an oil filtration chamber 38 in the center of the filter cartridge 16, with the oil filtration chamber 38 being open on its distal end. The axis of the threaded oil pipe 30 coincides with the central oil chamber 38, and in the preferred embodiment coincides with the axis of the filter cartridge 16/central oil chamber 38. The inside-out radial flow direction from the central oil chamber 38 through the filter medium 36 allows the prior art HD-1 filter element 16 to be used with the present invention. The inside-out radial flow direction through the HD-1 filter element 16 also allows the perforated metal sheath 34 to support the paper accordion filter material 36, with the perforated metal sheath 34 protecting the filter material 36 and the accordion pattern during handling.

The HD-1 filter element 16 includes a temperature responsive built in relief valve (not shown) to allow media by-pass on cold starts. During normal operation, an end cap 40 on the proximal end of the filter cartridge 16 ensures that the oil must flow radially outward through the filter medium 36 to exit the filter cartridge 16. The end caps 40, 42 are crimped to the metallic sheath 34 to form a fail proof assembly. A spring 44 attached on the annular distal end cap 42 biases the filter cartridge 16 proximally to hold the filter cartridge 16 in place. The distal end cap 42 of the filter cartridge 16 includes a shoulder 48 with an o-ring 50 which mates against a distally facing shoulder 46 of the canister 12 to position the cartridge 16 within the canister 12. The outer diameter of the perforated metallic sheath 34 is smaller than the inner diameter of the canister 12, so oil can flow longitudinally toward the proximal end of the filter/cooler 10 after it has moved through the filter medium 36. The length of the filter cartridge 16 is shorter than the length of the canister 12, so oil can flow radially inward after passing the proximal end cap 40 of the cartridge 16 to reach the port nut 14 and the oil return pipe 30. For instance, in the preferred embodiment the canister 12 is about 6 inches long and defines an inner chamber receiving the filter cartridge 16 which is about 4.2 inches long. The filter cartridge 16 is itself (not including the spring 44) about 4.2 inches long, meaning a gap is left around the proximal end of the filter cartridge 16 equal to the combined thickness of the distal end cap 42 and the o-ring 50, i.e., a preferred gap around the proximal end of the filter cartridge 16 of about 0.15 inches.

The end cap 18 screws into the canister 12 to hold the filter cartridge 16 in place within the canister 12, such as with about 2¾ inch 16 UNC threads. The end cap 18 is removable from the canister 12 to allow removal and replacement of the filter cartridge 16. A compressible gasket or o-ring 54 may be disposed between the end cap 18 and the canister 12 to better seal the end cap 18 to the canister 12. In contrast to many prior art designs, the canister 12 of the present invention can remain attached to the motor 28 during changing of the filter cartridge 16.

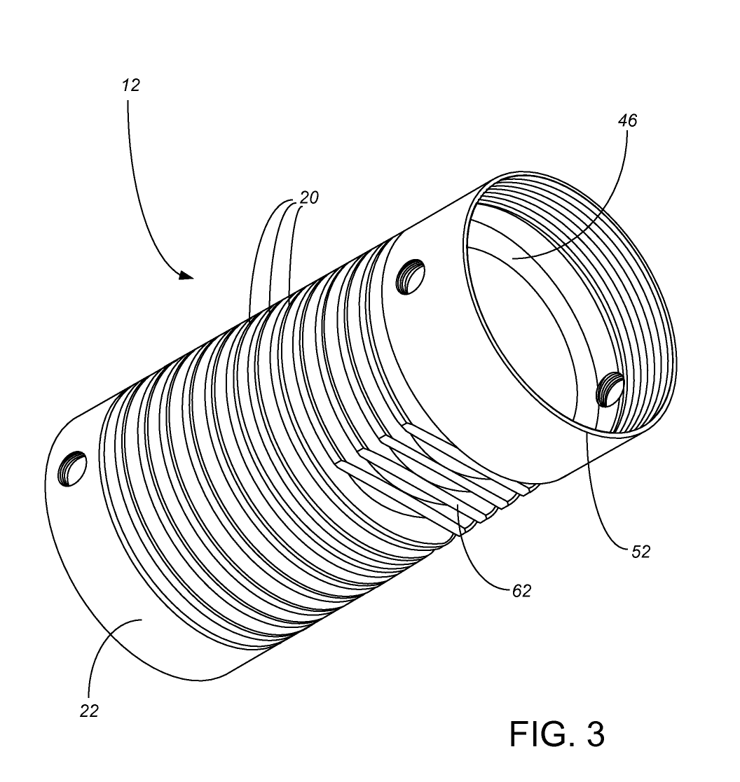

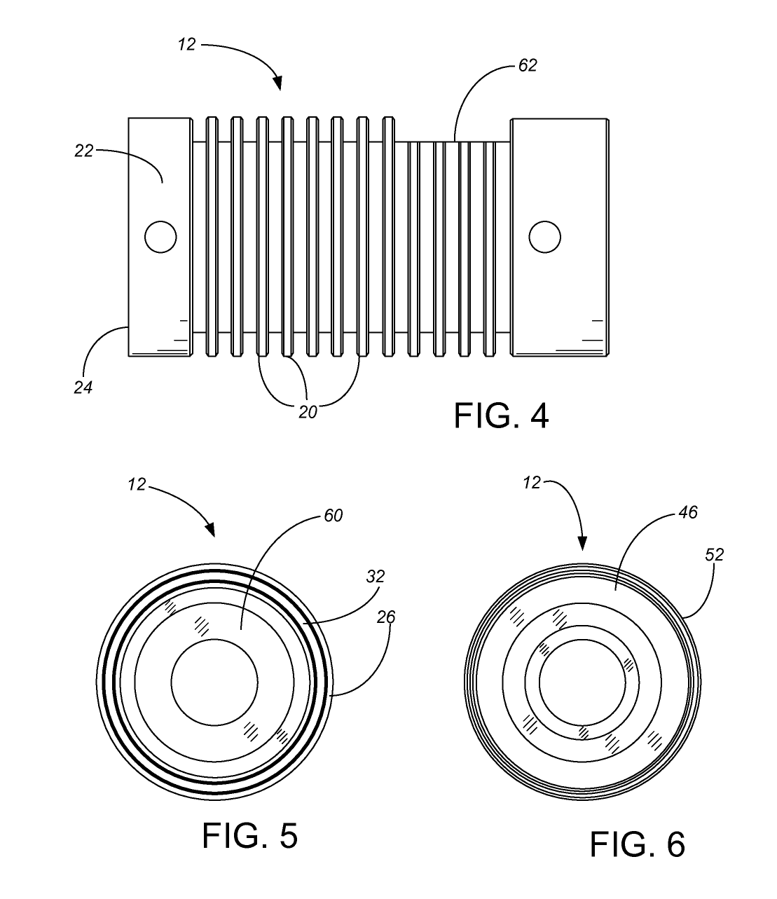

As shown in FIGS. 1 and 2, the canister 12 includes piping 56 or one or more equivalent passageways for oil flow outside the fins 20. In the preferred configuration, piping is provided by two rubber tubes 56 running longitudinally on the outside of the canister 12, and the oil flows in the distal direction through the two rubber tubes 56. This piping is attached to the canister 12 by a fitting 58 on each end. For instance, the preferred embodiment utilizes four metal L-shaped fittings 58 such as formed of brass, which are threadedly attached to the canister 12. The preferred fittings 58 are commonly commercially available such as with a ⅛ inside diameter, ⅛″ NPT thread having about a 0.4 inch outside diameter on the threads. The two fittings 58 on the proximal side of the canister 12 communicate with an oil reception chamber 60 on the proximal side of the canister 12. The two fittings 58 on the distal side of the canister 12 communicate with the central oil filtration chamber 38. Because the canister 12 attaches to the engine 28 without rotation of the canister 12, the tubes 56 can be positioned in a circumferential location so as to not interfere with any structure (not shown) on the engine 28. As shown in FIGS. 3 and 4, the exterior of the canister 12 can also be shaped such as with a recess in its cylindrical profile, in this case a flat 62, to avoid interference with other engine 28 components (not shown).

A basic unique feature of the present invention is the oil flow direction relative to the cooling and filter surfaces. Namely, the hottest oil is carried, outside the canister 12 and through one or more hoses or tubes 56, to the distal end of the canister 12. Then the oil flow direction turns around and flows monotonically within the canister 12 toward the engine 28. Within the canister 12, the oil is accordingly hottest at the distal end, and then cools due to the fins 20 and traversal through the filter element 16 from distal to proximal. That is, oil flow within the canister 12 is in a direction opposite the direction of conductive heat flow through the canister 12 from the engine 28. This is in contrast to many prior art filter/coolers, wherein the hottest oil enters the proximal (closest to the engine 28) part of the canister and stays within the canister.

Heat conducted from the engine block 28 necessarily enters from the proximal side of the canister 12, which in the invention is opposite the hottest oil. With this heating cross-flow direction (wherein the axial flow of conduction heat is opposite the hot oil flow direction), the canister 12 of the present invention is less likely to develop a temperature gradient from proximal to distal end, resulting in more even and more effective cooling of the oil.

The oil flow within the canister 12 is in a single direction from one end of the filter element 16 to the other end, which better uses the filter element 16 associated with the cooling function. There is no possibility that a mass or “plug” of cooler oil can set up in the distal end of the filter/cooler 10 while oil only circulates through the proximal end of the filter/cooler 10. This results in better overall cooling of the oil and more even use of the surface area of the filter element 16. In contrast, prior art designs (wherein the oil enters and exits from the same proximal side of the filter cartridge) can allow the oil to only utilize the proximal end of a new filter cartridge, when the filter medium is largely unclogged and permits ready flow-through, with substantial oil flow through the distal end of the filter cartridge only occurring after the proximal end of the filter medium has clogged with filtrate.

By having the cap 18 screwed onto the distal end of the canister 12, any oil spillage during changing the filter element 16 occurs at a position well removed away from the engine 28. An additional embodiment includes a stopcock (not shown) or other similar port on the distal end of the filter/cooler 10 (on the cap 18, or in the distal end of the canister 12, or in one of the elbow fittings 58), allowing oil to be drained from the filter/cooler 10 during changing of the disposable HD-1 filter element 16. The end cap 18 shown in FIGS. 1 and 2 has a knurled outer surface to allow hand tightening and opening/removal.

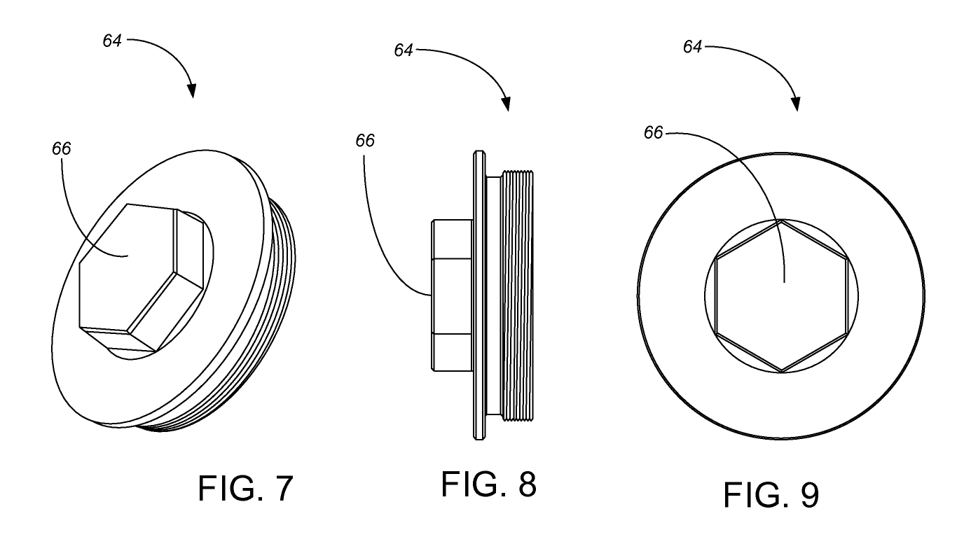

FIGS. 7-9 show an alternative end cap 64 having a hexagonal head projection 66. The hex-head 66 on the alternative screw on cap 64 allows for torquing the cap 64 open with a wrench (not shown), in case it gets stuck to the canister 12 during the time period of use.

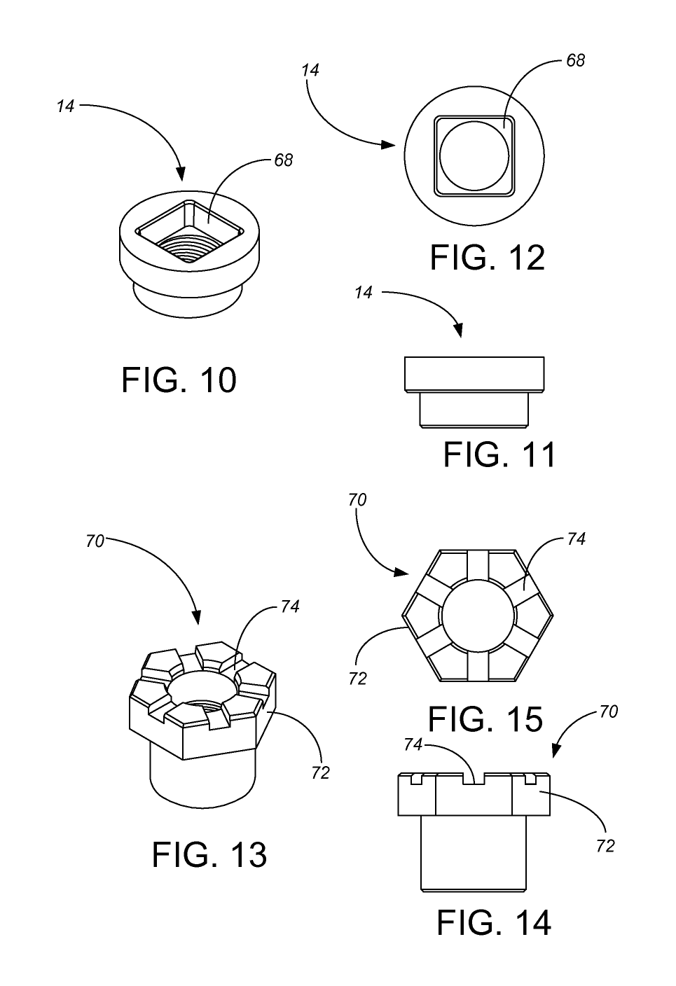

FIGS. 10-12 show a first preferred embodiment of a clamp port nut 14. A distal side of the clamp port nut 14 includes a ¾ inch square drive recess 68, for mating with a common ¾ inch square drive tool (not shown) extending through the middle of the canister 12 before the HD-1 filter element 16 is positioned in place. The proximal side of the clamp port nut 14 has an outer diameter of about 1.1 inches in diameter, to just fit with a slight clearance within the corresponding proximal side opening through the canister 12. The distal side of the clamp port nut 14 is wider than its proximal side, such as an outder diameter of about 1⅜ inches, so the clamp port nut 14 can hold the canister 14 to the engine 28 while extending though the corresponding proximal side opening of the canister.

FIGS. 13-15 show a second preferred embodiment of a clamp port nut 70. A distal side of this clamp port nut 70 has a hexagonal profile 72, for wrench or socket tightening. Additionally, the distal side includes recesses 74 for tightening with a screwdriver type of tool (not shown) extending through the middle of the canister 12 before the HD-1 filter element 16 is positioned in place.

Although the present invention has been described with reference to preferred embodiments, workers skilled in the art will recognize that changes may be made in form and detail without departing from the spirit and scope of the invention.

1. An oil filter/cooler comprising:
a canister having a plurality of fins defined on an outer surface of the canister, the canister defining an oil filtration chamber within its interior, the canister having a proximal end with a circular sealing surface sized to mate with a circular sealing surface on an engine around a threaded oil pipe, with an oil reception chamber defined inside the circular sealing surface; and
piping attached to the canister and defining an oil flow path running from the oil reception chamber exterior to the plurality of fins to a distal end of the canister before connecting to the oil filtration chamber.

2. The oil filter/cooler of claim 1, wherein the piping comprises a plurality of oil hoses running longitudinally along the canister.

3. The oil filter/cooler of claim 2, wherein the oil hoses are rubber.

4. The oil filter/cooler of claim 2, further comprising fittings which screw in to the canister, with the oil hoses running between fittings.

5. The oil filter/cooler of claim 4, wherein the fittings are metal

6. The oil filter/cooler of claim 1, wherein the fins extend circumferentially around the canister.

7. The oil filter/cooler of claim 1, wherein the canister is machined from aluminum.

8. The oil filter/cooler of claim 1, wherein the distal end of the canister comprises a removable end cap, the removable end cap permitting access to the oil filtration chamber; the oil filter/cooler further comprising:
a replaceable oil filtration medium disposed within the oil filtration chamber which can be removed from the canister after removal of the removable end cap.

9. The oil filter/cooler of claim 1, wherein oil flow through the replaceable oil filtration medium is inside-out within a filter cartridge, with the piping delivering oil to a center of the replaceable filter cartridge.

10. The oil filter/cooler of claim 1, wherein the canister comprises a port nut receiving shoulder, the oil filter/cooler further comprising:
a port nut having an annulus with interior threads sized to mate with exterior threads of the threaded oil pipe of the engine, the port nut being rotatable to attach the canister to the engine.

11. The oil filter/cooler of claim 11, wherein the canister provides a cylindrical profile and including a recess in the cylindrical profile to avoid interference with other engine components.

12. The oil filter/cooler of claim 1, wherein oil flow within the canister is monotonically in a direction opposite a direction of conductive heat flow through the canister from the engine.

13. An oil filter/cooler comprising:
a canister having a plurality of fins defined on an outer surface of the canister, the canister defining an oil filtration chamber within its interior, the canister having a proximal end with a circular sealing surface sized to mate with a circular sealing surface on an engine around a threaded oil pipe, with an oil reception chamber defined inside the circular sealing surface; and
a replaceable filter cartridge disposed within the oil filtration chamber, the filter cartridge being annular with a filtration medium around a central oil chamber, with an axis of the threaded oil pipe coinciding with the central oil chamber, wherein oil flow through the filtration medium is inside-out before returning through the threaded oil pipe.

14. The oil filter/cooler of claim 13, wherein a distal end of the canister comprises a removable end cap, the removable end cap permitting access to the oil filtration chamber.

15. The oil filter/cooler of claim 13, wherein the canister comprises a port nut receiving shoulder, the oil filter/cooler further comprising:
a port nut having an annulus with interior threads sized to mate with exterior threads of the threaded oil pipe of the engine, the port nut being rotatable to attach the canister to the engine.

16. The oil filter/cooler of claim 15, wherein the canister provides a cylindrical profile and including a recess in the cylindrical profile to avoid interference with other engine components.

17. The oil filter/cooler of claim 16, further comprising:
piping attached to the canister and defining an oil flow path running from a proximal side of the canister to a distal side of the canister, the piping running exterior to the plurality of fins.

18. A method of cooling and filtering oil, comprising:
placing a canister about a threaded oil return pipe on an engine, the canister having a plurality of fins defined on an outer surface of the canister, the canister having a proximal side contacting the engine and a free distal side;
attaching the canister to the engine by tightening a port nut onto the threaded oil return pipe;
placing a replaceable filter cartridge within the canister, the replaceable filter cartridge being disposed about an axis of the oil return pipe; and
piping oil from the proximal side of the canister, outside the plurality of fins to the distal side of the canister for the oil to be filtered by the filter cartridge.

19. The method of claim 18, wherein the canister comprises a removable end cap, and further comprising:
after placing the replaceable filter cartridge within the canister, replacing the end cap onto the canister.
